(19) United States
(12) Patent Application Publication
(10) Pub. No.: US 2005/0119859 A1
(43) Pub. Date: Jun. 2, 2005

(54) Optimal Surface Mitigated Multiple Targeting System (OSMMTS)

(75) Inventor: Timothy Grant Hall, Cambridge, MA (US)

Correspondence Address: TIMOTHY HALL;PQI CONSULTING, P.O. BOX 425616, CAMBRIDGE, MA, 02142-0012, US

(73) Assignee: PQI CONSULTING, Cambridge, MA (US)

(21) Appl. No.: 10/709,878

(22) Filed: Jun. 2, 2004

Related U.S. Application Data
(60) Provisional application No. 60/481,718, filed on Nov. 28, 2003.

(51) Int. Cl. G06F 15/00

(52) U.S. Cl. 702/181

(57) ABSTRACT

A set of analytical methods and a processing system to produce, in real time, an error-bounded, self-monitoring and self-adjusting, likelihood-based Target Position Report for arbitrarily many self-identifying targets in a two-dimensional grid. Each target sends identifying information to an array of sensors strategically placed in its vicinity to maximize the likelihood that the system will produce a position report as accurately and precisely as possible.

### BACKGROUND OF INVENTION

The concept of utilizing an array of sensors to calculate a position report is well represented in the prior art. Patents as far back as Koeppel, U.S. Pat. No. 2,855,595, October 1958, have utilized “a plurality of reference points” (this expression is used in Heldwein, et al., U.S. Pat. No. 4,229,737, October 1980) as a basis for determining an object's position. Additional references to arrays of sensors and reference points for locating a “vehicle” or “transceiver” include Drouilhet, et al., U.S. Pat. No. 5,570,095, October 1996; Nilsson, U.S. Pat. No. 4,524,931, June 1985; Chisholm, U.S. Pat. No. 3,412,399, November 1968, and Fletcher, et al., U.S. Pat. No. 3,153,232, October 1964. In fact, Jandrell, U.S. Pat. No. 5,526,357, June 1996, as a continuation of U.S. Pat. No. 5,365,516, August 1991, extends the use of the sensor array to a “two-way message delivery system for mobile resource management,” including the use of “a control center containing means for determining the location of the polled transponder.” In a related track, a “method and system for highly accurate navigation of . . . ships and aircraft” using “transmitted wave energy at regular intervals” was described in Beasley, U.S. Pat. No. 4,024,383, May 1977. In addition, the use of “multilateration,” i.e., the use of multiple sensors to calculate positions from transmitted signals, is used in jandrell (cited above), Saito, et al, U.S. Pat. No. 4,673,921, June 1987; Fuller, et al., U.S. Pat. No. 3,646,580, February 1972; and as far back as Ross, U.S. Pat. No. 2,972,742, February 1961.

A recent development found in Smith, et al., U.S. Pat. No. 6,094,169, July 2000, includes a “correction method” for multilateration “based on a signal from secondary radar.” Furthermore, modern, widely used systems such as GPS (Global Positioning Satellites), LORAN (Long-range Radio Navigation), and Lo-Jacks® use differential arrival times at “a plurality of reference points” to produce their position reports, with claims of “excellent” accuracy given proximity constraints.

However, none of these existing patents, with the information found collectively in the prior art, adequately addresses four practical, critical issues that are completely solved by the OSMMTS. The prior art either completely ignores these issues, such as in the cited pre-1980 patents, or only briefly touches on the issues without providing objective, justifying documentation. The four critical issues left unsatisfied in the prior art may be called the Issues of Likelihood of Accuracy, Maintenance, Universality, and Optimality. The OSMMTS completely addresses these issues as follows: [ ]1. All data transmissions, from whatever source or through whichever medium, are subject to error, whether through corrupted transmission, fraudulent use, or aberrant conditions. When information is received at a sensor, data corruption in some sense is always possible, as well as abhorrent signals from reflections, or even from intentional false data inserted to deceive the sensing equipment. The extent and efficiency with which a method or system addresses the potential presence of corrupted data determines how useful that method or system may be. This is the Issue of Likelihood of Accuracy, i.e., how likely are the position reports accurate and to what extent can it detect “false” or “impossible” or even “unlikely” data? Can the method or system consistently produce a position report within a given distance, say, 95% of the time over, say, a 24-hour period using only “valid” data? This issue is touched upon in Smith, et al., U.S. Pat. No. 6,094,169, July 2000, without quantification, by use of a secondary radar system, which may or may not be applicable outside of aviation uses, and which may or may not be as accurate as the original position report. Furthermore, Beasley, U.S. Pat. No. 4,024,383, May 1977, claims to produce a “highly accurate” report, again without justification. The prior art otherwise contains very little objective quantification concerning the Issue of Likelihood of Accuracy, if it is addressed at all. Without quantifying and controlling the likelihood of an inaccurate position report in a meaningful and automatic manner, the method or system under consideration cannot be trusted to produce useful information.

The OSMMTS contains non-obvious, novel, and critically useful analytical algorithms and data structures that quantify the Likelihood of Accuracy of each position report individually at the time of calculation, and collectively as further processing continues. Furthermore, data that has been corrupted or intentionally altered is sensed automatically by the analytical methods, thus preventing this data from corrupting the position report. This important OSMMTS feature ensures that any given position report may be trusted, in the sense that the probability that it represents a significantly incorrect report may be made arbitrarily small by adjusting the calculation parameters in the analytical methods.

2. All electrical and mechanical equipment, such as the “array of sensors ” or “plurality of reference points” mentioned in the prior art, is subject to malfunction, sometimes manifested as catastrophic failure, but more often as a slow, cumulative wearing out of control. The ability of a method or system to sense when a sensor, or group of sensors, has reached a point where its cumulative wear is now producing significantly erroneous data, is critical to the usefulness of such a method or system. If one cannot tell when the system is reporting garbage, how can its output be trusted? This is the Issue of Maintenance. The prior art is silent on the integration of concurrent maintenance of a target reporting system. No mention is made in the prior art concerning a method or system that can sense during its operation when a sensor has significantly wore out of control.

The OSMMTS contains analytical methods, data structures, and an operational policy for discerning during its operation when a sensor has significantly wore out of control or has failed outright. Each position report is evaluated for consistency and likelihood of applicability to detect when sensors may be wearing out of control, or when “impossible” data has been received. This ongoing surveillance of the data quality involved in the calculations is automatically applied to the reporting subsystem without the need for outside, primary monitoring. This vitally useful and novel OSMMTS feature is not addressed in the prior art.

3. The pertinent prior art that utilizes an array of sensors to calculate a position report always refers to a context specific to the patent. Beasley, U.S. Pat. No. 4,024,383, May 1977, refers to “ships and aircraft,” while Jandrell, U.S. Pat. No. 5,526,357, June 1996, specifically mentions “mobile resource management” with respect to where equipment are at a given moment. And Drouilhet, et al., U.S. Pat. No. 5,570,095, October 1996, refers to “vehicles,” meaning equipment that physically resembles an automobile or cart. Since there is always a particular context in which the patent is described, the prior art fails to address the Issue of Universality, where the methods and system in question work equally well regardless of implementation context. For example, the OSMMTS error-bounding methods work equally well when the sensors are microscopic entities in an animal's bloodstream, or detecting aircraft at great distances, or in tracing vortex changes in a tornado. The OSMMTS is context neutral, or context independent, which the prior art does not claim, as it could not support such a claim.

4. The final feature of the OSMMTS not addressed by the prior art is the Issue of Optimality. The prior art makes no attempt to optimize its performance from a priori information. For example, Smith, et al., U.S. Pat. No. 6,094,169, July 2000, refers to an “error correction” through a signal from a secondary radar interrogation (with clear context to a ground-based radar system most commonly used in aviation surveillance). However, the extent to which the “error” is “corrected” due to characteristics of the secondary radar system is not addressed, nor even mentioned in the preferred embodiment. In other words, is the error correction due to Radar System #1 better than that from the use of Radar System #2, and if so, by how much, and why? And why is such a correction an improvement on the original position report? [ ]The OSMMTS addresses the Issue of Optimality by defining objective, analytical methods for optimizing the performance of the OSMMTS before any data is collected, or before any calibration is needed. This distinguishes the OSMMTS from the prior art by minimizing the natural introduction of error into position calculations through numerical optimization algorithms.

### SUMMARY OF INVENTION

The purpose of the Optimal Surface Mitigated Multiple Targeting System (OSMMTS) is to encapsulate the analytical methods and processing system necessary to produce, in real time, an error-bounded, self-monitoring and self adjusting, likelihood-based Target Position Report for arbitrarily many self-identifying targets in a two-dimensional grid. Each target sends identifying information to an array of sensors strategically placed in its vicinity to maximize the likelihood that the system will produce a position report as accurately and precisely as possible. The OSMMTS uses analytical and ad-hoc mitigation and optimization techniques to reduce the error bounds on the Target Position Report to a practical minimum. The OSMMTS consists of the analytical methods, construct guidelines, quantification methods, mitigation and optimization techniques, and programming details for implementing the system in hardware and software in such a manner as to allow Target Position Report calculations arbitrarily frequently.

### BRIEF DESCRIPTION OF DRAWINGS

FIG. 1 depicts the data processing interaction between the PASIC, the related databases, and the SDU's. This interaction facilitates the production of the Target Position Report.

FIG. 2 depicts the cyclic nature of the signal timing used in mitigations for reflections and other optimizations.

### DETAILED DESCRIPTION

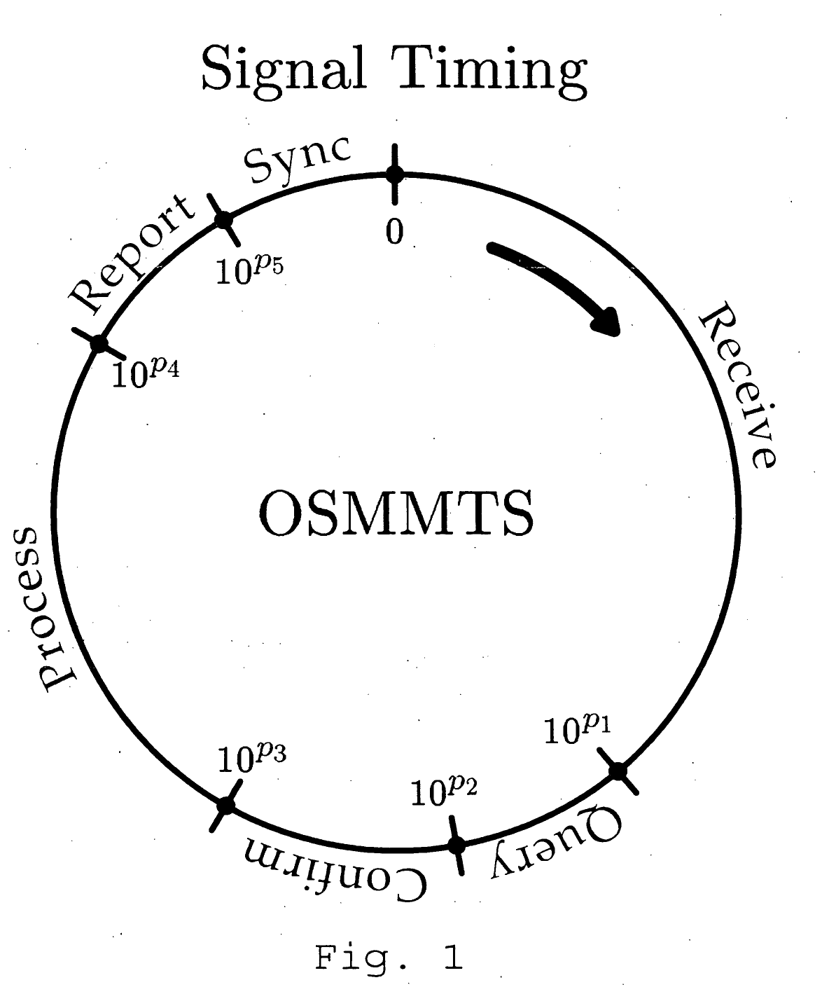

The OSMMTS interface consists of one Principal Application Specific Integrated Circuit (ASIC) Central Processing Unit (CPU), generically referred to as the PCPU, a set of (at least four) remote sensing Surface Detection Units (SDU) that send information to the PCPU, and a database of statically stored data that the PCPU accesses for parameter data, algorithm exceptions, and other information, which are used to produce the Target Position Report, as well as supporting reports as the implementation determines (see FIG. 1). The PCPU, SDU's, and any database systems must be coordinated on and agree with an absolutely maintained time system, accurate to at least twice the precision of the anticipated Target Position Report.

A Target Position Report (TPR) is generated whenever a SDU sends a stream of timing information to the PCPU. Since different SDU will send information at different times about the same target, an absolute timing schedule must be used to ensure valid comparison of timing data from the SDU set.

A Target T may only initiate a signal to the SDU set when t=0 mod ξ, where ξ=(10\hat{ }n)/ρ cycles in a 10\hat{ }n Hz PCPU, where there are ρ signals per second. For example, if a target sends a signal to the SDU set every half second, then ρ=2, and ξ=((10\hat{ }n)/2)=((10\hat{ }n)/(10\hat{ }{log_{—}10 2}))=10\hat{ }{n−log_{—}10 2}.

The Effective Range of the OSMMTS System is the maximum time for this receive/query/confirm period. It measures the farthest a target may be away from the closest qualifying set of SDU's and still be detected by the system.

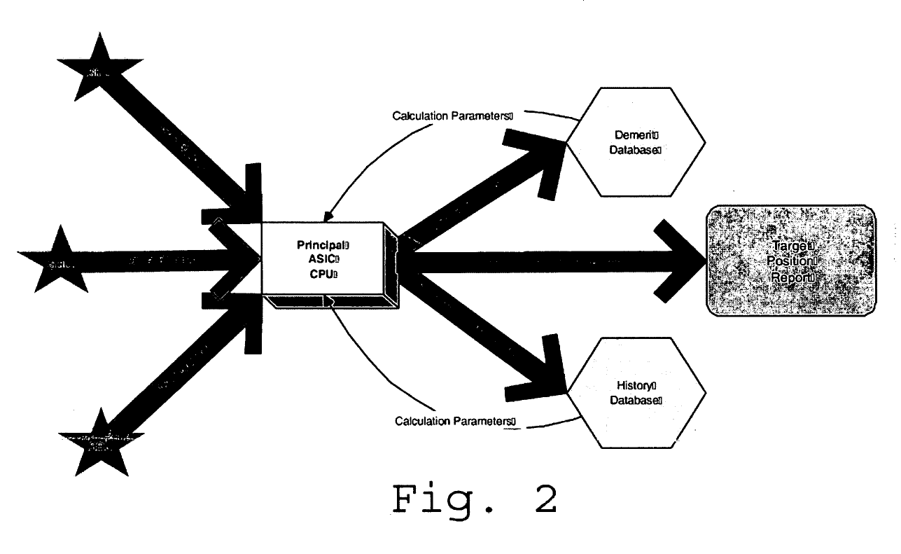

A complete Signal Period, i.e., ξ=(10\hat{ }n)/ρ cycles in a 10\hat{ }n Hz PCPU, consists of six Phases, each encompassing an interaction between the PCPU, the SDU set, and the parameter database (see FIG. 2).

The Phases are: 1. Receive, during which the PCPU receives the detected signal information from the SDU set. This phase must last as long as the effective range, plus overhead time for communications between the SDU set and the PCPU. The information passed during this phase consists of: a. SDU ID b. Target ID c. Time Of Signal Detection. The SDU and Target ID are static codes used throughout all phases and signal periods. If either the SDU ID or the Target ID changes during a signal period, it must be through a formal change management process incorporated into the particular implementation of the OSMMTS System. It shall be the responsibility of the OSMMTS implementation to ensure that changing SDU ID and/or Target get ID are linked properly for inference purposes. The Time of Signal Detection is relative to the common absolute timing mechanisms in the OSMMTS System.

2. Query, during which the PCPU queries the sending SDU for a confirmation code to ensure communication integrity. If the confirmation code sent by the SDU is not correct (see the next phase), the PCPU queries the SDU again for the proper confirmation code. This is repeated up to a tunable number of iterations. If no correct confirmation code is received in the allotted time, the SDU is deactivated.

3. Confirm, during which the PCPU receives and processes the confirmation code sent by the SDU. It is during this phase that any required re-transmissions are also requested, received, and disposed.

4 Process, during which all calculations are completed to produce the Target Position Report, and subsequent reports for evaluation, quantification, and adjustment purposes.

5. Report, during which the Target Position Report and supporting information are made available on output channels, and during which any auxiliary communications with the SDU's are completed.

6. Sync, during which no processing activity is scheduled.

This is useful when coordinated processing activities require synchronized signal periods.

One signal period begins when the previous one ends. The sync phase may be used to coordinate any overhead processing issues to implement this requirement.

The Error Likelihood Ellipse (ELE) is the standardized elliptical region that represents the highest likelihood of the actual position of the target. A special constant is used to form the ellipse, called the Standardized Elliptical Constant (SEC).

A TPR is said to be accurate if the calculated position of the target is inside the ELE for the same data as was used to calculate the TPR. The SEC determines the likelihood of this event.

Any calculation algorithm used to produce a set of numerical values intermediate and inferior to the TPR is called an analytical step.

An analytical step is called a mitigation if it is taken before the arrival time data {t1, t2 . . . t_{k}, . . . } are collected.

An analytical step is called an optimization if it occurs after the arrival time data {t1, t2 . . . t_{k}, . . . } are collected.

The purpose of mitigation steps is to reduce the error variance σ.

The purpose of optimization steps is to increase the likelihood of an accurate TPR.

An irregularly occurring, non-analytical step taken at any time to accomplish the same goals as mitigation and optimization is called ad-hoc.

The collection of ad-hoc, mitigation, or optimization steps taken in an implementation of the OSMMTS is called the system's containment policies, and referred to individually as a system containment policy.

The OSMMTS Demerit System is an ad-hoc containment policy that acts simultaneously as a mitigation and an optimization. Under this system, the three SDU's chosen to calculate the TPR are those three that are most likely to produce the “best” TPR based on past performance (thereby making it a optimization step), by way of reducing the variability of the utilized data (thereby making it a mitigation step).

Suppose there are n-many SDU's, however, only k≦n many receive a signal within the reception window. There are (n choose k)-many combinations of SDU's, and (k choose 3)-many combinations of the k-many that receive the signal taken three at a time. Each SDU has three values associated with it at the beginning of each processing cycle, namely its non-negative Demerit Count, its positive History Total, and its possibly null Boolean Confirmation Value. At the beginning of all processing, the demerit count for each SDU will be zero, the history total will be one, and the confirmation value will be null. The confirmation value at the beginning of the processing cycle is determined by its observed value during the confirmation cycle. At the end of a processing cycle, the demerit count and history total are determined by the steps below, and the confirmation value is set back to null.

For each processing cycle, and for each of the (k choose 3)-many combinations, the following steps determine the end-of-processing-cycle demerit counts and history totals. 1. Set the likelihood value λ. 2. Eliminate those ô0-many combinations that are collinear. 3. Eliminate those ô1-many combinations that do not all have positive history totals and TRUE confirmation values. The SDU's involved in the (τ0+τ1)-many combinations eliminated in Steps 2-3 are called deficient for the current processing cycle. This designation is removed at the beginning of a new processing cycle. 4. Among the remaining, i.e., qualifying combinations, choose the combination of three SDU that collectively have the minimal sum of demerits. 5. In case of a tie in Step 4, use the combination with the largest history sum. In case of a further tie, choose the combination with the smallest individual demerit count. In case of a last tie, randomly choose uniformly among the finalists. The combination so chosen is called the calculating combination, and the SDU's involved are called the elected SDU's. Increment the history total by 1 for each elected SDU. 6. Subtract two demerits from the count for each elected SDU. Recall the demerit count for an SDU cannot become negative. 7. Calculate the TPR using the calculating combination. 8. Calculate the λ-ELE for the calculating combination. 9. Calculate the (k choose 3)−(ô0+ô1)-many TPR for all other qualifying combinations. Each of these TPR is called an Alternate Position Report (APR). 10. For each APR calculated in Step 9, if the APR falls outside the λ-ELE, then add one demerit to the count for each SDU involved in the APR. 11. For each APR calculated in Step 9, if the APR falls inside or on the ë-ELE, then subtract one demerit to the count for each SDU involved in the APR. Recall the demerit count for an SDU cannot become negative. 12. Add one demerit for each SDU that does not report a positive confirmation. 13. When the demerit count for an SDU exceeds the Warning Threshold, send an alert to report a frequently deficient SDU. 14. When the demerit count for an SDU exceeds the Terminal Threshold, shut down communication with the SDU and do not consider it further (by setting its history total to zero) until explicitly reset. Also send an alert to report a failed SDU. 15. These steps are in addition to the disabling of an SDU if proper query responses are not confirmed during the receive phase.

See also the included PQIC technical documentation memorandum for a complete analytical description of the OSMMTS methods and processes.

1. A method for a. Analytically calculating a Target Position Report for arbitrarily many self-identifying targets in a two-dimensional grid.

2. A system, comprising a one Principal Application Specific Integrated Circuit Central Processing Unit that implements the said method of claim 1. b. a set of (at least three) Surface Detection Units that send information to the said Principal Application Specific Integrated Circuit Central Processing Unit. c. a network of databases of statically stored data that the said Principal Application Specific Integrated Circuit Central Processing Unit uses to produce the said Target Position Report.

3. A system of claim 2, wherein said information sent from the said Surface Detection Units to the said Principal Application Specific Integrated Circuit Central Processing Unit is uniquely coded in a format that a. The said Principal Application Specific Integrated Circuit Central Processing Unit uses to identify the said communicating Surface Detection Unit. b. The said network of databases of statically stored data uses to update its data.

4. A method of claim 1, wherein said step of calculating said Target Position Report provides a. An Error Likelihood Ellipse. b. A Likelihood of Accuracy measure of said Target Position Report using the said Error Likelihood Ellipse.

5. A method of claim 1, wherein said step of calculating said Target Position Report uses a. Arrival times at a said set of Surface Detection Units. b. A Demerit System. c. Containment policies to maximize the said Likelihood of Accuracy.

6. A system of claim 2, wherein said Surface Detection Units are a. Physically distinct from the said Principal Application Specific Integrated Circuit Central Processing Unit. b. Coordinated to a master timing clock administered by the said Principal Application Specific Integrated Circuit Central Processing Unit. c. Optimally located to maximize the said Likelihood of Accuracy.

7. A method of claim 1, wherein said step of calculating said Target Position Report is a. Performed on one set of incoming data before another set of said incoming data is processed, i.e., the calculations are performed “in real time.” b. Self-monitoring as to accuracy. c. Self-adjusting as to accuracy. d. Likelihood-based as to accuracy. e. Error bounded, in the sense that the said Likelihood of Accuracy may be made arbitrarily large by adjusting the characteristics of said set of Surface Detection Units.

8. A method of claim 1, wherein a. Said Target Position Reports may be calculated arbitrarily frequently. b. Said step of claim 5 of using containment policies to maximize the said Likelihood of Accuracy is implemented analytically in the said Principal Application Specific Integrated Circuit Central Processing Unit. c. Said step of claim 6 of optimally locating said Surface Detection Units to maximize the said Likelihood of Accuracy is implemented analytically in the said Principal Application Specific Integrated Circuit Central Processing Unit.
